(19) United States
(12) Patent Application Publication
(10) Pub. No.: US 2015/0097733 A1
(43) Pub. Date: Apr. 9, 2015

(54) Antenna

(71) Applicant: Wistron Neweb Corporation, Hsinchu (TW)

(72) Inventor: Shih-Chiang Wei, Hsinchu (TW)

(73) Assignee: Wistron Neweb Corporation, Hsinchu (TW)

(21) Appl. No.: 14/261,449

(22) Filed: Apr. 25, 2014

(30) Foreign Application Priority Data
Oct. 4, 2013 (TW) 102136059

(51) Int. Cl. H01Q 9/04

(52) U.S. Cl. CPC H01Q 9/04
USPC 343/700 MS

(57) ABSTRACT

An antenna for wideband and multi-band operations includes a grounding sheet for providing grounding, a radiating element extending from a first terminal near an edge of the grounding sheet to a second terminal near the edge of the grounding sheet, including at least a bend and substantially encompassing an area with the edge of the grounding sheet, a feeding element electrically connected to the first terminal of the radiating element for transmitting electromagnetic energy, and a first extending radiating element disposed in the area, electrically connected to the grounding sheet and substantially zigzagging along the radiating element; wherein a length of the radiating element is related to a first operating frequency band of the antenna, and a length of the first extending radiating element is related to a second operating frequency band of the antenna.

### BACKGROUND OF THE INVENTION

1. Field of the Invention

The present invention relates to an antenna, and more particularly, to an antenna with wideband, multiband operation, small size, and high efficiency.

2. Description of the Prior Art

An antenna is utilized for transmitting or receiving radio frequency waves so as to communicate or exchange wireless signals. An electronic product with wireless communication functionality, such as a laptop and a personal digital assistant (PDA), usually accesses a wireless network through a built-in antenna. Therefore, to facilitate access to the wireless communication network, an ideal antenna should have a wide bandwidth and a small size to meet the trends of compact electronic products within a permissible range, so as to integrate the antenna into a portable wireless communication equipment. However, with advances in wireless communication technology, operating frequencies of different wireless communication systems may vary, and thereby, an ideal antenna should cover bandwidths required for different wireless communication networks with a single antenna.

For example, Long Term Evolution (LTE) system covers a wide range of frequency bands. To meet the multiband applications, a prior art method is to equip with multiple antennas to respectively transmit and receive signals of different frequency bands, which causes increase of deign complexity and space for settling the antennas. If the available space for the antennas is limited, interference may occur among the antennas, which significantly affects performance of the antennas. Therefore, providing an antenna that allows multiband operation under limited space is a significant objective in the field.

### SUMMARY OF THE INVENTION

It is therefore a primary objective of the present invention is to provide a multiband antenna so as to achieve multiband or wideband operation in a limited area.

An embodiment of the present invention discloses an antenna for wideband and multiband operations comprises a grounding sheet for providing grounding, a radiating element extending from a first terminal near an edge of the grounding sheet to a second terminal near the edge of the grounding sheet, comprising at least a bend and substantially encompassing an area with the edge of the grounding sheet, a feeding element electrically connected to the first terminal of the radiating element for transmitting electromagnetic energy, and a first extending radiating element disposed in the area, electrically connected to the grounding sheet and substantially zigzagging along the radiating element; wherein a length of the radiating element is related to a first operating frequency band of the antenna, and a length of the first extending radiating element is related to a second operating frequency band of the antenna.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a schematic diagram illustrating a monopole antenna.

FIG. 1B is a schematic diagram illustrating a voltage standing wave ratio (VSWR) of the monopole antenna in FIG. 1A.

FIG. 2A is a schematic diagram illustrating an antenna according to an embodiment of the present invention.

FIG. 2B is a schematic diagram illustrating VSWR of the antenna in FIG. 2A.

FIG. 3A is a schematic diagram illustrating an antenna according to an embodiment of the present invention.

FIG. 3B is a schematic diagram illustrating VSWR of the antenna in FIG. 3A.

FIG. 4A is a schematic diagram illustrating an antenna according to an embodiment of the present invention.

FIG. 4B is a schematic diagram illustrating VSWR of the antenna in FIG. 4A.

FIGS. 5A to 5D are schematic diagrams respectively illustrating current vector of the antenna in FIG. 4A operating in different frequency.

FIGS. 6A, 6B and 7 are schematic diagrams illustrating antennas according to embodiment of the present invention.

FIG. 8 is a schematic diagram illustrating a laptop.

### DETAILED DESCRIPTION

A monopole antenna is a simple structured and widely used antenna, which is mainly composed of a metal line and a reference plane (e.g. grounding sheet). However, since a length of the metal line should substantially equal to a half of a wavelength of a radio frequency (RF) signal corresponding to an operating frequency band, the length of the metal line may be extended, causing disadvantages such as high inductive, poor matching, bandwidth deficiency and poor space utilization efficiency. Therefore, to solve drawbacks of the prior art monopole antenna is a significant objective in the field.

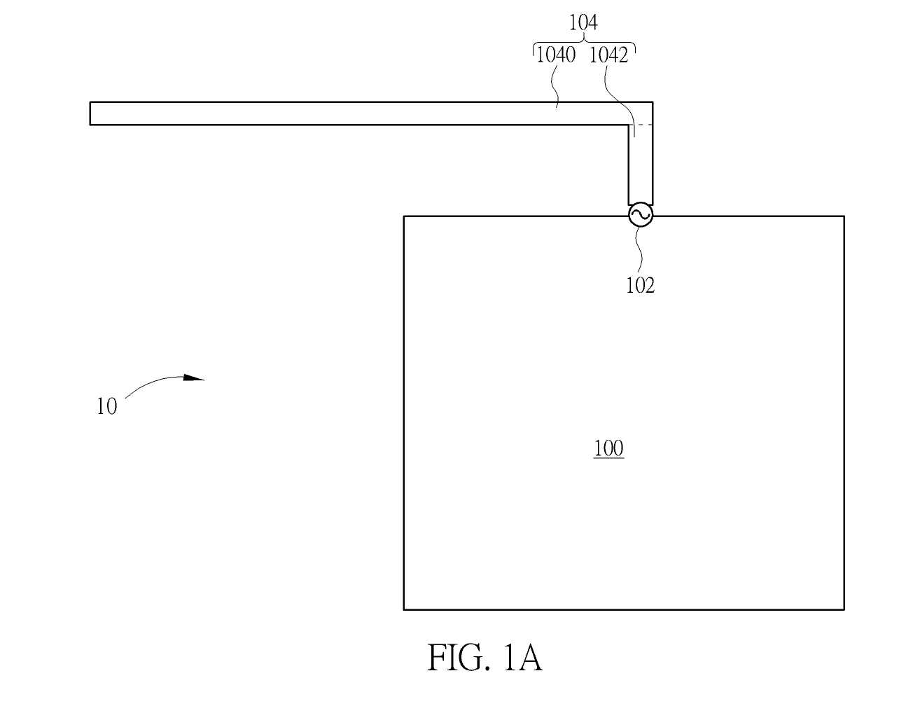

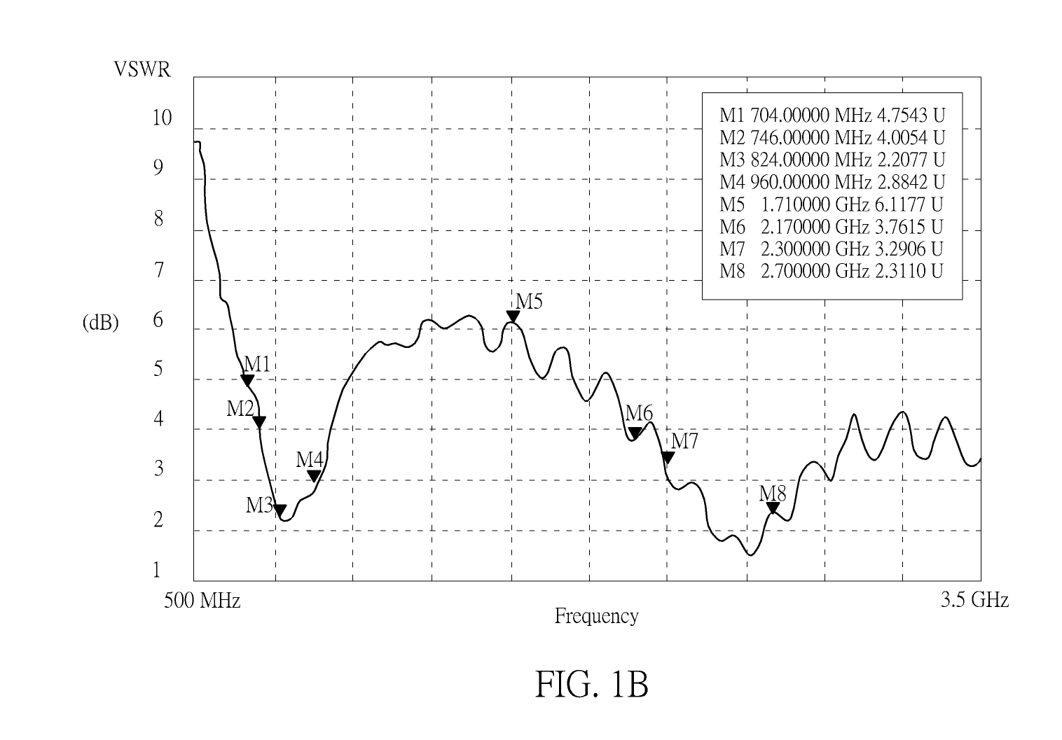

Please refer to FIGS. 1A and 1B. FIG. 1A is a schematic diagram of a monopole antenna 10. FIG. 1B is a schematic diagram of a voltage standing wave ratio (VSWR) of the monopole antenna 10. The monopole antenna 10 is suitable for Long Term Evolution (LTE) system, and comprises a grounding sheet 100, a feeding element 102 and a radiating element 104. The grounding sheet 100 is utilized for providing grounding, the feeding element 102 is utilized for delivering energy, and the radiating element 104 is utilized for transmitting and sensing electromagnetic signals. The radiating element 104 includes a first segment 1040 and a second segment 1042, which are electrically connected and substantially perpendicular to each other to form an inverted-L shape. The first segment 1040 is parallel to a top edge of the grounding sheet 100. A signal wire of the feeding element 102 is electrically connected to the second segment 1042, and a grounding wire thereof is electrically connected to the grounding sheet 100.

Due to the inverted-L shape, a height of the radiating element 104 is efficiently reduced to improve efficiency of space utilization. Nevertheless, as can be seen from FIG. 1B, the monopole antenna 10 still suffers from poor matching and bandwidth deficiency in high and low frequencies around the frequency bands required for the LTE system. As a result, the monopole antenna 10 cannot fully meet all the requirements for the LTE system. In such a situation, the present invention further provides a wideband antenna which is capable of supporting multiband operations.

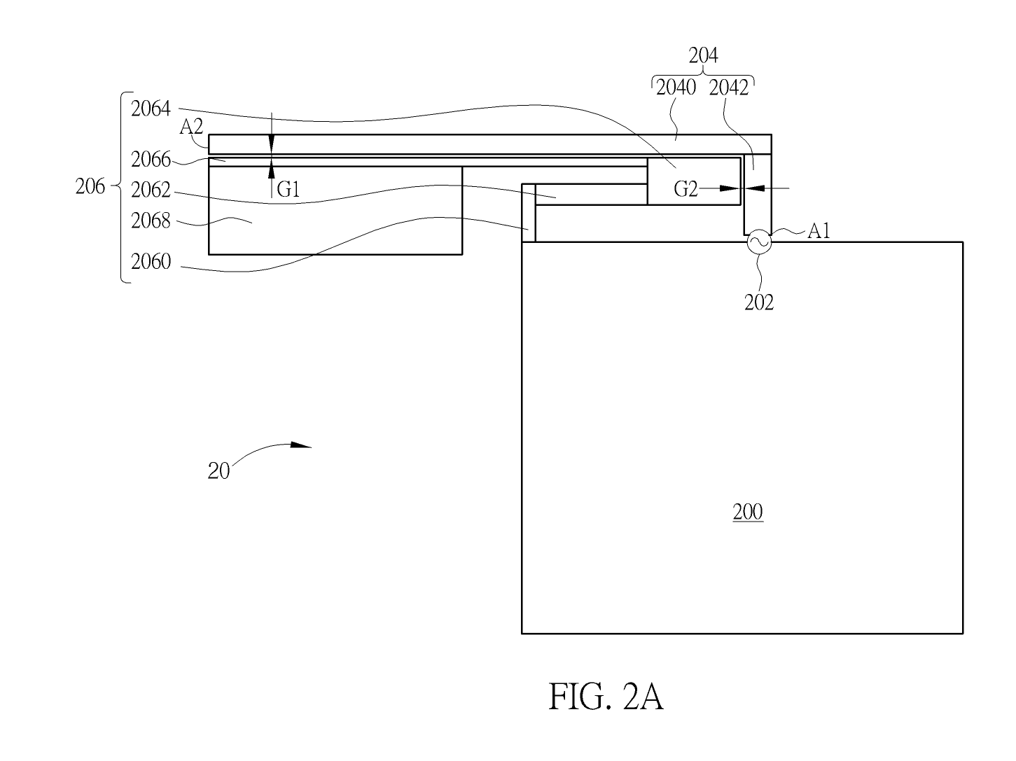

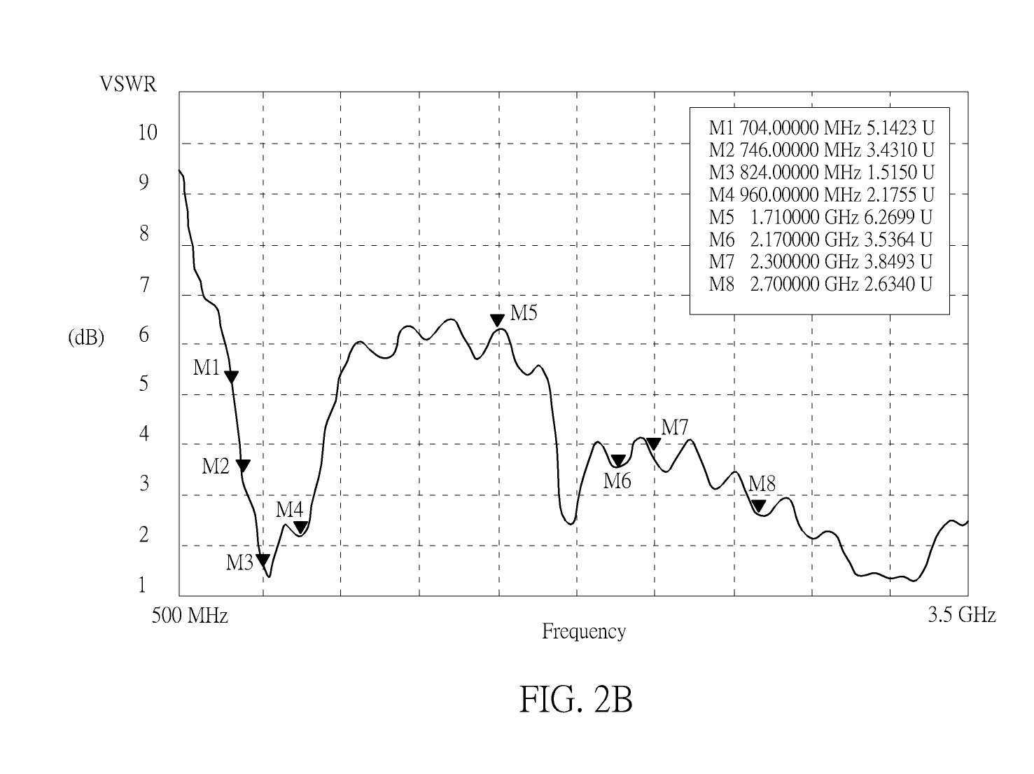

Please refer to FIGS. 2A and 2B. FIG. 2A is a schematic diagram of an antenna 20 according to an embodiment of the present invention. FIG. 2B is a schematic diagram of VSWR of the antenna 20. The antenna 20 is made of metal material, and comprises a grounding sheet 200, a feeding element 202, a radiating element 204, and a first extending radiating element 206. By comparing FIGS. 1A and 2A, the antenna 20 further comprises the first extending radiating element 206 in comparison to the antenna 10, and the rest structures are substantially the same. Note that, FIG. 2A is derived from the antenna 10 shown in FIG. 1A, in order to clearly illustrate the embodiment of the present invention. However, the present invention is not limited to be applied to the inverted-L antenna 10, which and may also be applied to monopole antennas of other types.

In FIG. 2A, the grounding sheet 200 is utilized for providing grounding, the feeding element 202 is utilized for delivering energy, and the radiating element 204 is utilized for transmitting and sensing electromagnetic signals. The radiating element 204 comprises a first segment 2040 and a second segment 2042, which are electrically connected and substantially perpendicular to each other to form an inverted-L shape extending from a first terminal A1 near a top edge of the grounding sheet 200 to a second terminal A2. In this embodiment, the first segment 2040 is parallel to the top edge of the grounding sheet 200. A signal wire of the feeding element 202 is electrically connected to the second segment 2042, and a grounding wire thereof is electrically connected to the grounding sheet 200. In addition, the first extending radiating element 206 is electrically connected to the grounding sheet 200, substantially separates from the first segment 2040 by a first gap G1 and from the second segment 2042 by a second gap G2, and zigzags alone the first segment 2040 and the second segment 2042. The gap G1 maybe utilized for adjusting a degree of coupling between the first extending radiating element 206 and the first segment 2040, and the gap G2 may be utilized for adjusting a degree of coupling between the first extending radiating element 206 and the second segment 2042. In other words, the first extending radiating element 206 is substantially disposed in the area encompassed by the first segment 2040, the second segment 2042, and the top edge of grounding sheet 200. In detail, according to a shape of the first extending radiating element 206, the first extending radiating element 206 can be divided into segments 2060, 2062, 2064, 2066 and a parasitic block 2068. The segment 2066 is parallel to the first segment 2040, and substantially separates from the first segment 2040 by the first gap G1. The segment 2064 is parallel to the second segment 2042, and substantially separates from the second segment 2042 by the second gap G2. The parasitic block 2068 is rectangular, for adjusting properties such as matching condition and/or frequency range.

In the antenna 20, a total length of the first segment 2040 and the second segment is substantially related to a frequency band around 700 MHz, e.g., the total length can be substantially equal to or close to a quarter of a wavelength of a wireless signal corresponding to 700 MHz. A total zigzagging length of the first extending radiating segment 206 is substantially related to a frequency band around 800 MHz, e.g., the total length can be substantially equal to or close to a quarter of a wavelength of a wireless signal corresponding to 800 MHz. In such a situation, by comparing FIG. 1B and FIG. 2B, the first extending radiating element 206 activates another radiating pattern at low frequencies, to improve low operating frequency bandwidth. Meanwhile, the first extending radiating element 206 may be coupled to the radiating element 204, such that matching effect at low frequencies may be improved. In addition, frequency bandwidth and matching may also be increased and improved at multiples of 700 MHz and 800 MHz.

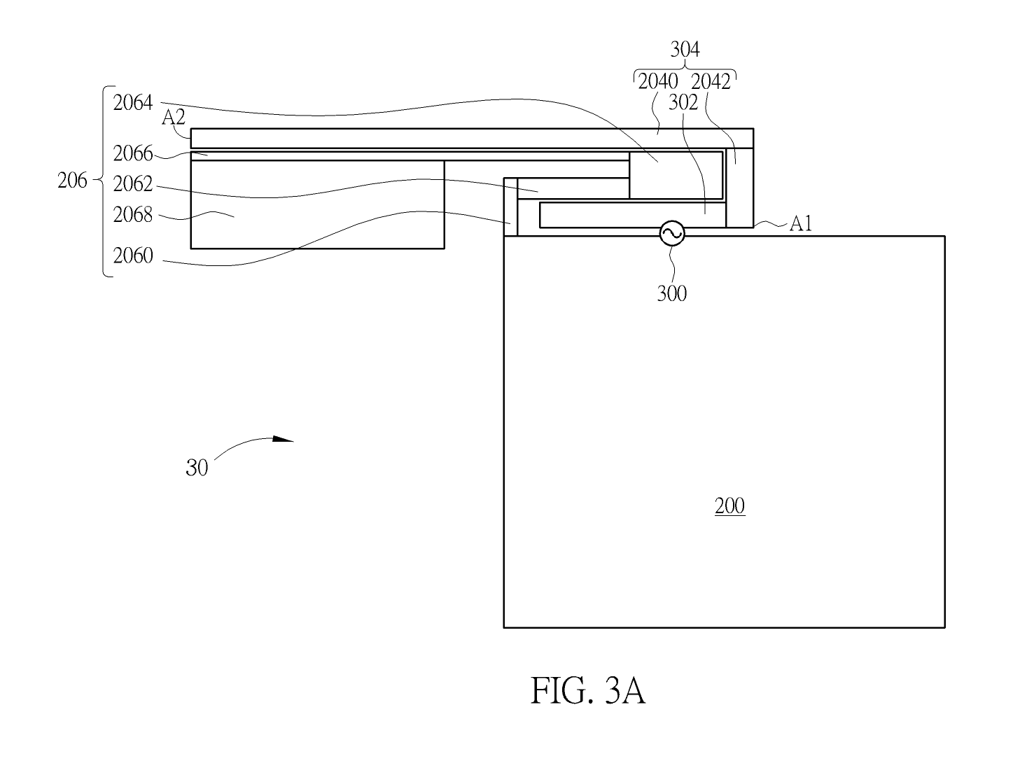

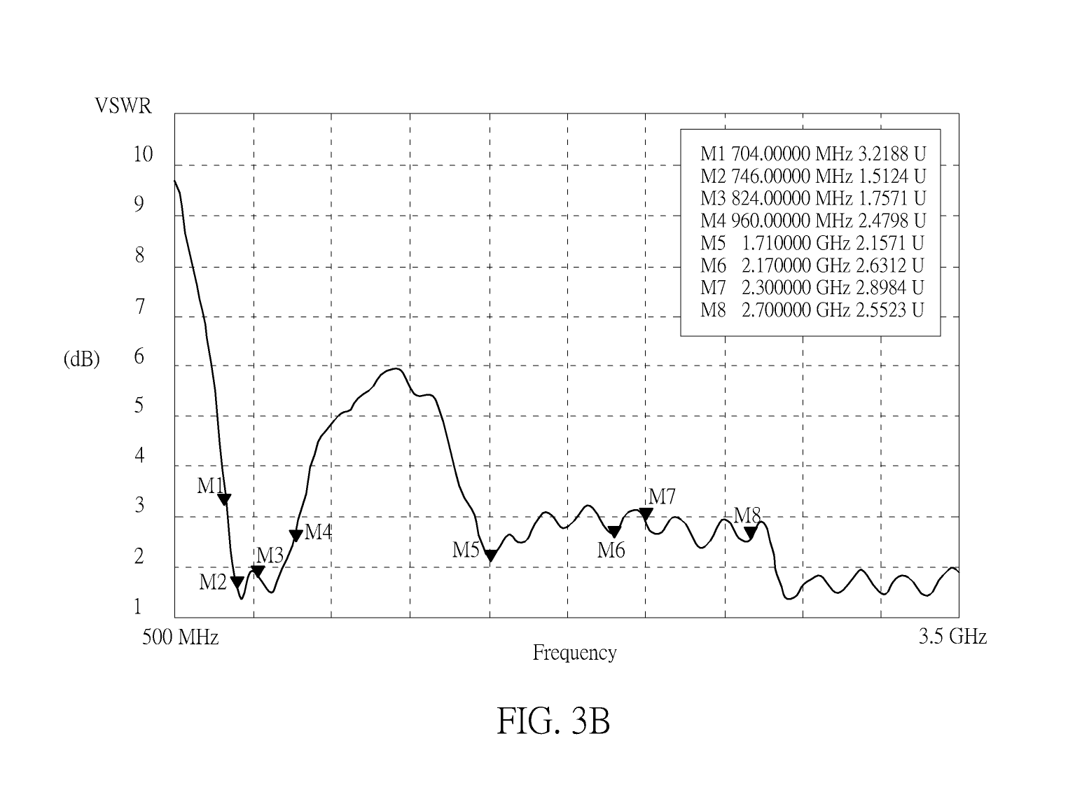

As can be seen from FIG. 2B, in comparison to the antenna 10, the antenna 20 obviously improves operating frequency bandwidths and matching at high and low frequencies for LTE system. Furthermore, please continue to refer to FIGS. 3A and 3B. FIG. 3A is a schematic diagram of an antenna 30 according to an embodiment of the present invention. FIG. 3B is a schematic diagram of VSWR of the antenna 30. Since the structures of the antennas 30 and 20 are similar, notations of the same components remain the same. The antenna 30 is also made of metal material. Different from the antenna 20, a radiating element 304 of the antenna 30 further comprises an extending segment 302 in comparison to the radiating element 204 of the antenna 20. The extending segment 302 is electrically connected to the first terminal A1 of the segment 2042. A signal wire of the feeding element 300 of the antenna 30 is connected to the extending segment 302. Moreover, a total length of the extending segment 302 is substantially related to a frequency band around 2.7 GHz, e.g., the total length of the extending segment 302 may be substantially equal to or close to a quarter of a wavelength of a wireless signal corresponding to 2.7 GHz. In such a situation, as can be seen by comparing FIG. 2B and FIG. 3B, the extending segment 302 activates another radiating pattern at high frequencies, to improve operating frequency bandwidth at high frequencies. Meanwhile, the extending segment 302 is coupled to the first extending radiating element 206, such that matching effect is improved. In addition, a difference between the feeding element 300 of the antenna 30 and the feeding element 202 of the antenna 20 is the connecting position. That is, the feeding element 300 is electrically connected to the extending segment 302, and the feeding element 202 is electrically connected to the second 2042, such that the bandwidth and matching are improved as well.

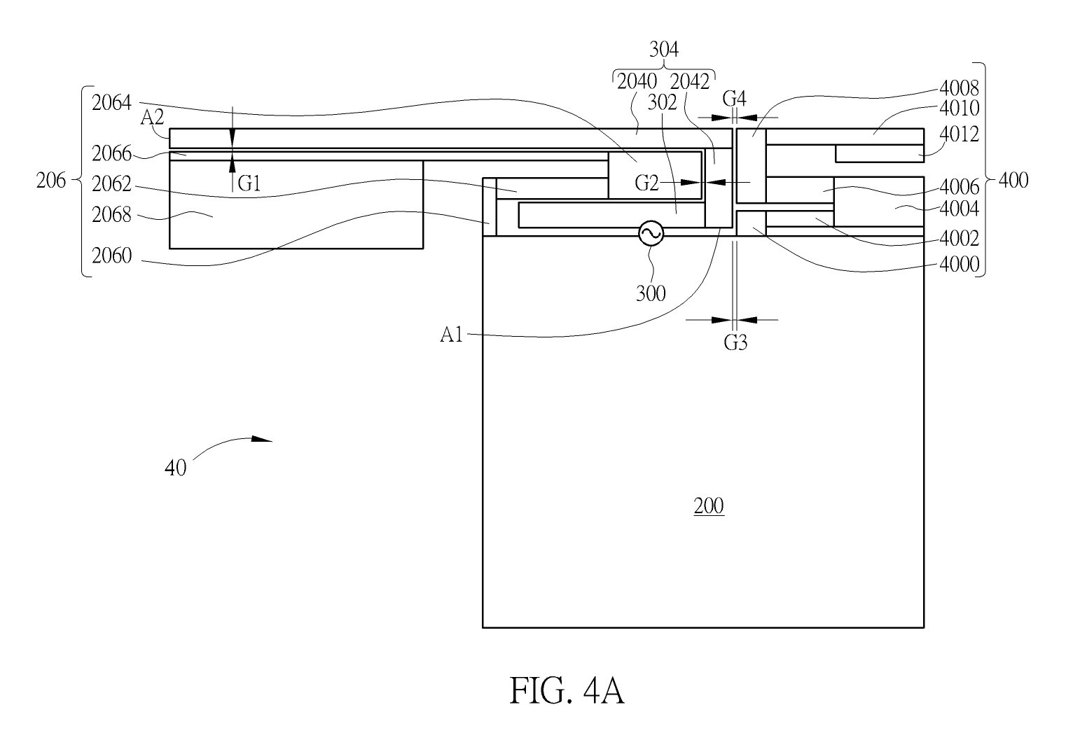

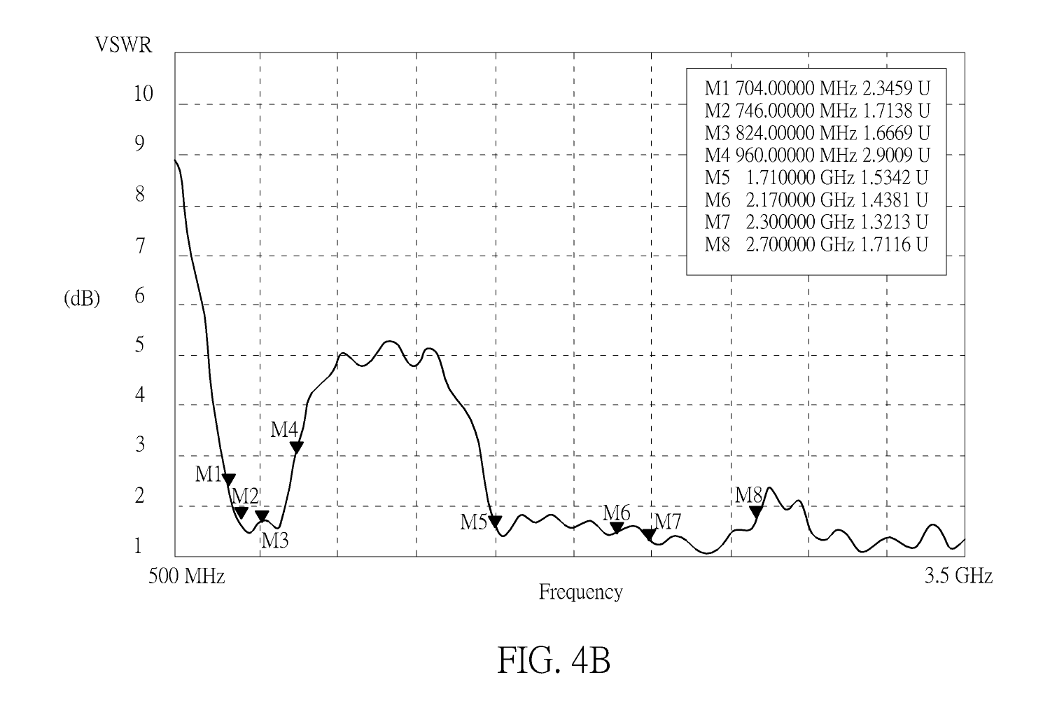

As can be seen from FIG. 3B, in comparison to the antenna 20, the antenna 30 improves operating frequency bandwidths and matching for LTE system. Furthermore, please continue to refer to FIGS. 4A and 4B. FIG. 4A is a schematic diagram of an antenna 40 according to an embodiment of the present invention. FIG. 4B is a schematic diagram of VSWR of the antenna 40. Since the structures of the antennas 40 and 30 are similar, notations of the same components remain the same. The antenna 40 is also made of metal material. Different from the antenna 30, the antenna 40 further comprises a second extending radiating element 400 in comparison to the antenna 30, and the rest structures are substantially the same. The second extending radiating element 400 is electrically connected to the grounding sheet 200, substantially separates from the second segment 2042 by gaps G3 and G4, and extends alone the second segment 2042. The gaps G3 and G4 are utilized for adjusting degrees of coupling between the second extending radiating element 400 and the second segment 2042. The second extending radiating element 400 is divided into segments 4000, 4002, 4004, 4006, 4008, 4010 and a parasitic block 4012, according to shapes thereof. To accommodate to a settling space, the second extending radiating element 400 contains multiple bends. Moreover, the segment 4000 is parallel to the second segment 2042, and substantially separates from the second segment 2042 by the gap G3. The segment 4008 is also parallel to the second segment 2042, and substantially separates from the second segment 2042 by the gap G4. The parasitic block 4012 is rectangular, which is utilized for adjusting properties such as matching condition and/or frequency range.

In the antenna 40, a total length of the second extending radiating element 400 is substantially related to a frequency band around 1.7 GHz, e.g., the total length of the second extending radiating element 400 may be substantially equal to or close to a quarter of a wavelength of a wireless signal corresponding to 1.7 GHz. In such a situation, as can be seen by comparing FIG. 4B and FIG. 3B, the second extending radiating element 400 activates another radiating pattern at high frequencies, to improve operating frequency bandwidth at high frequencies. Meanwhile, the second extending radiating element 400 is coupled to the second segment 2042, such that matching effect at high frequencies is improved. Therefore, the antenna 40 achieves wide bandwidth and high efficiency at both high and low frequencies. A table demonstrates the measured antenna efficiency results of the antenna 40, as follows.

| Freq. (MHz) | Effic. (dB) |
|---|---|
| 704 | −4.13 |
| 710 | −−3.98 |
| 716 | −3.88 |
| 734 | −3.75 |
| 740 | −3.71 |
| 746 | −3.11 |
| 751 | −3.03 |
| 756 | −3.05 |
| 777 | −2.99 |
| 782 | −2.87 |
| 787 | −2.74 |
| 791 | −2.93 |
| 806 | −3.11 |
| 821 | −3.46 |
| 824 | −3.53 |
| 836 | −3.47 |
| 849 | −3.28 |
| 862 | −3.62 |
| 869 | −3.78 |
| 880 | −4.10 |
| 894 | −4.37 |
| 900 | −4.52 |
| 915 | −4.71 |
| 925 | −4.97 |
| 940 | −5.29 |
| 960 | −5.43 |
| 1710 | −3.47 |
| 1730 | −3.31 |
| 1750 | −3.48 |
| 1770 | −3.57 |
| 1785 | −3.51 |
| 1805 | −3.68 |
| 1840 | −3.57 |
| 1850 | −3.61 |
| 1880 | −3.67 |
| 1910 | −3.72 |
| 1920 | −3.58 |
| 1930 | −3.41 |
| 1950 | −3.31 |
| 1960 | −3.36 |
| 1980 | −3.07 |
| 1990 | −2.95 |
| 2010 | −2.91 |
| 2018 | −2.88 |
| 2025 | −2.96 |
| 2110 | −2.89 |
| 2140 | −2.87 |
| 2170 | −2.95 |
| 2300 | −2.75 |
| 2325 | −2.80 |
| 2350 | −2.59 |
| 2375 | −3.00 |
| 2400 | −2.83 |
| 2500 | −2.54 |
| 2515 | −2.59 |
| 2535 | −2.51 |
| 2555 | −2.90 |
| 2570 | −2.77 |
| 2595 | −3.14 |
| 2620 | −3.15 |
| 2630 | −3.20 |
| 2655 | −3.25 |
| 2680 | −3.49 |
| 2690 | −3.41 |

As can be seen from the table above, the antenna 40 achieves high efficiencies at both high and low frequencies, thus satisfying the requirements of LTE system.

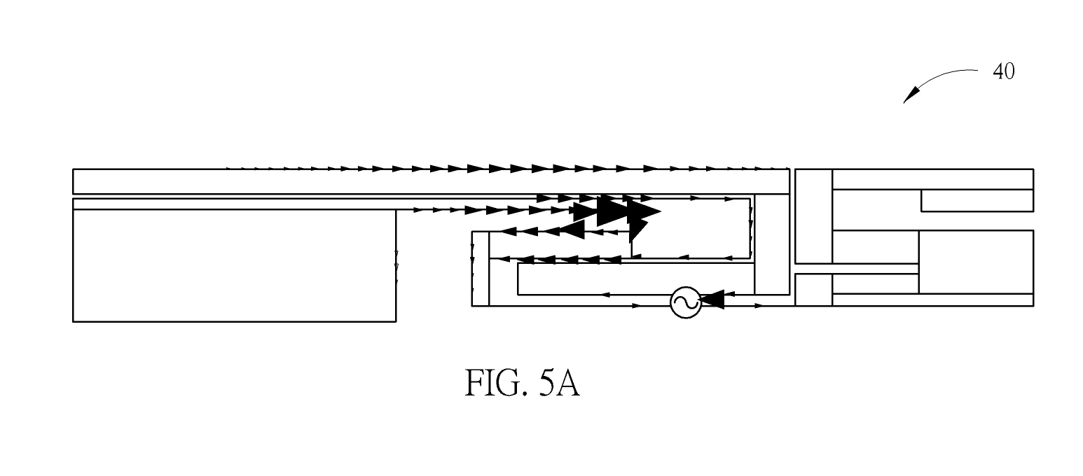

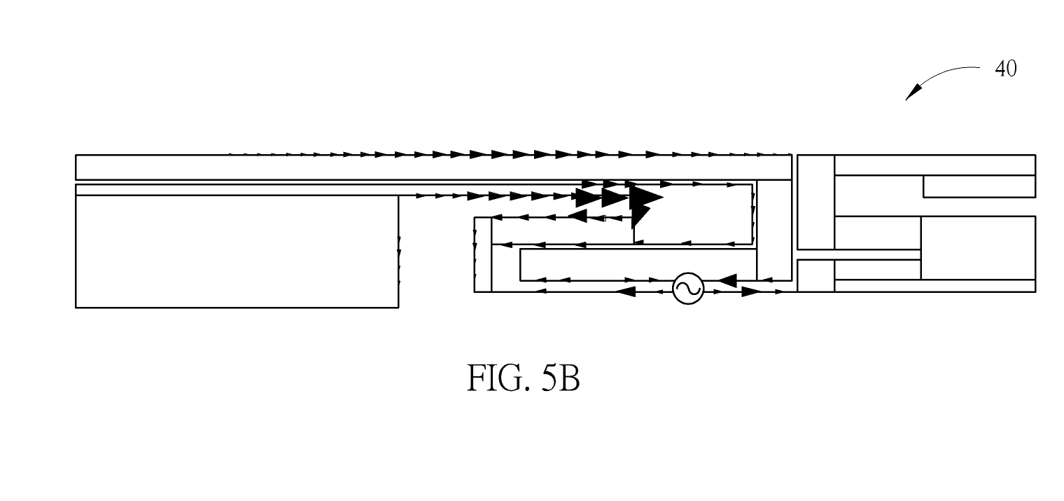

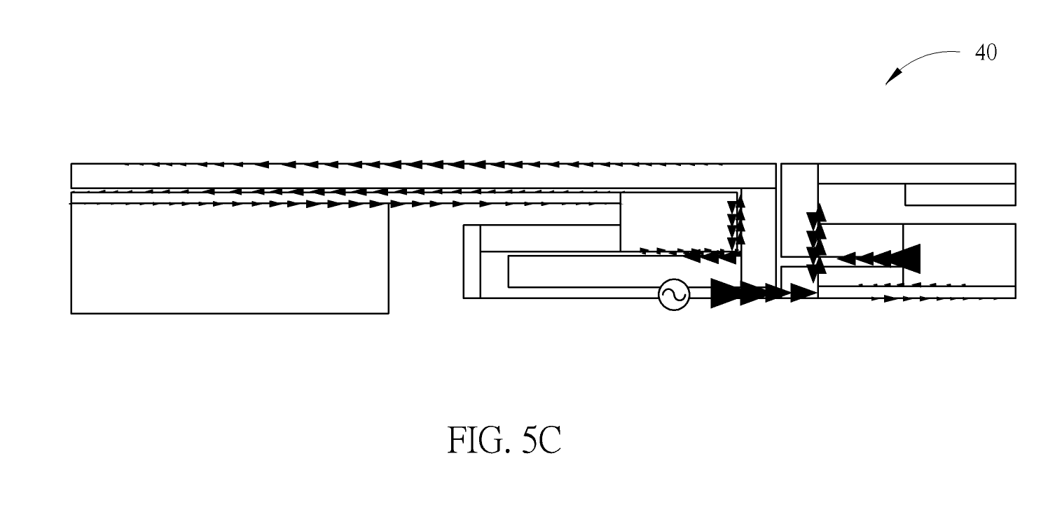

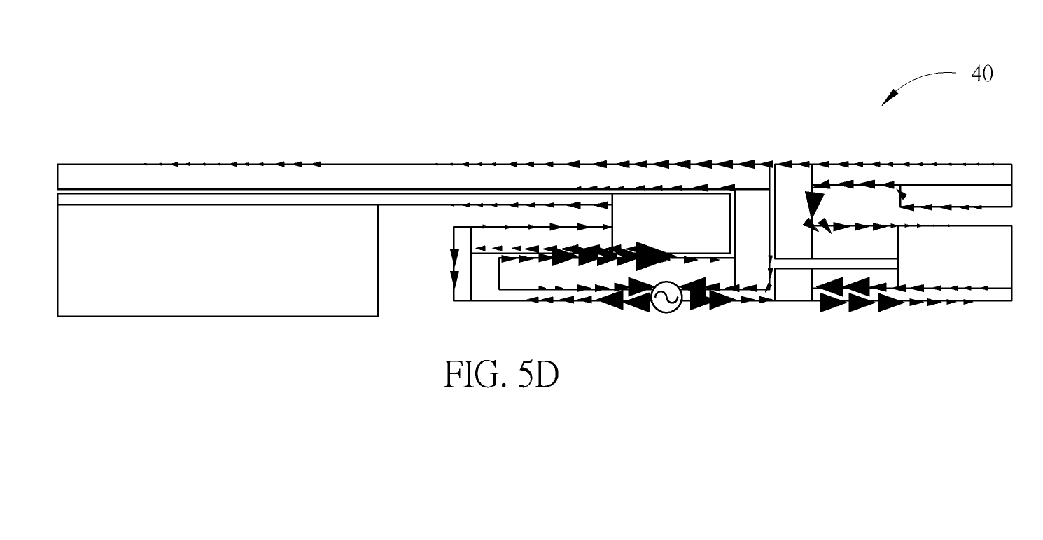

Furthermore, please refer to FIGS. 5A to 5D. FIGS. 5A to 5D are schematic diagrams of current vectors of the antenna 40 operating at 800 MHz, 900 MHz, 1900 MHz and 2500 MHz. For the sake of brevity, FIGS. 5A to 5D neglect most notations of the antenna 40. Only part of the components are illustrated. As can be seen from FIGS. 5A and 5B, the antenna 40 provides another current path through the first extending radiating element 206 at low frequencies, and the first extending radiating element 206 is coupled to the radiating element 304. As can be seen from FIGS. 5C and 5D, at high frequencies, the antenna 40 provides current paths through the first extending radiating element 206 and the second extending radiating element 400. The first extending radiating element 206 is coupled to the radiating element 304, and the second extending radiating element 400 is coupled to both the grounding sheet 200 and the second segment 2042. In addition, the antenna 40 provides another current path through the extending segment 302. Therefore, in addition to the total lengths of the first segment 2040 and the second segment 2042, the present invention further provides other parameters for adjusting antenna properties, e.g., the lengths or shapes of the first extending radiating element 206 and the second extending radiating element 400, the gaps G1-G4 from the first extending radiating element 206 and the second extending radiating element 400 to the radiating element 304, the length or shape of the extending element 302, the position of the feeding element 300, etc.

Therefore, by including the first extending radiating element 206, the extending segment 302, the second extending radiating element 400 and adjusting the feeding position, the antennas 20, 30 and 40 are able to widen the system bandwidth and improve matching condition in comparison to the antenna 10. Nevertheless, note that the antennas 20, 30 and 40 are embodiments of the present invention, and those skilled in the art can make alterations and modifications accordingly, but not limited thereto. For example, the L-shape formed by the first segment 2040 and the second segment 2042 is an exemplary example. In fact, the present invention may be applied to any monopole antenna, neither limited to L-shape nor consisting of two segments, which comprises at least one bend and substantially encompasses an area with an edge of a grounding sheet, to dispose the first extending radiating element 206. For example, in an embodiment, one or both of the first segment 2040 and the second segment 2042 maybe replaced by triangular or trapezoid segments, or segments with irregular shape, which means that the first segment 2040 and the second segment 2042 may have variation in width, such that the angle in between may be less than 90 degrees. In an embodiment, the radiating element 204 maybe realized by a metal segment with arc shape, or the joint (bend) connecting the first segment 2040 and the second segment 2042 may be in arc shape. Alternatively, in another embodiment, the radiating element 204 may be composed of multiple segments, comprising more than one bend or forming as an irregular or specified geometry shape.

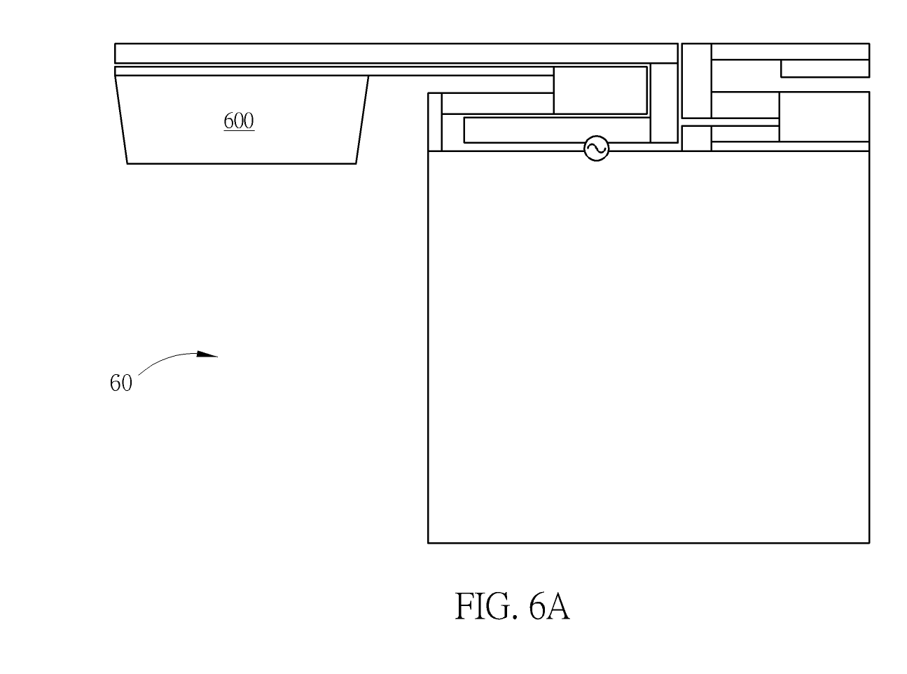

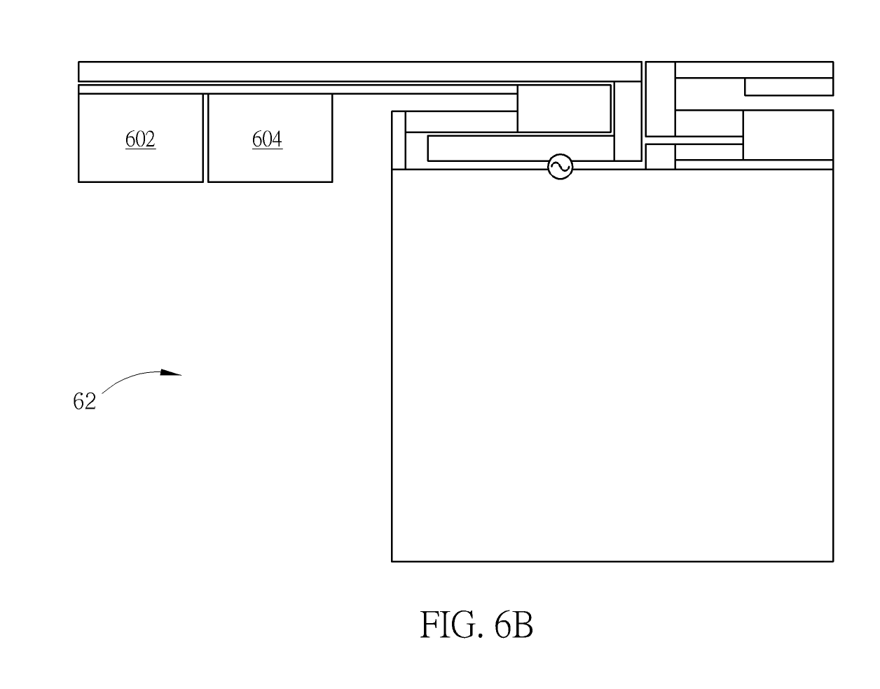

In addition, the segments 2060, 2062, 2064, 2066 and the parasitic block 2068 of the first extending radiating element 206 are distinguished by shapes. Multiple bends are included in order to accommodate the settling area. In fact, the number and the shape of the segments are not limited. The number and the shape of the parasitic blocks are not limited to be a single rectangle as well. Multiple geometric blocks maybe included. For example, FIGS. 6A and 6B are schematic diagrams of antennas 60 and 62, respectively, according to embodiments of the present invention. Since the structures of the antennas 60, 62 and 40 are similar, most notations of elements are neglected. Different from the antenna 40, a parasitic block 600 of an extending radiating element of the antenna 60 is trapezoid, and an extending radiating element of the antenna 62 comprises two parasitic blocks 602 and 604. Moreover, note that the trapezoid parasitic block 600 is for exemplifying purpose, and other geometric shapes such as triangular, semicircle and arc of parasitic blocks may also be applied to the present invention. Similarly, the two parasitic blocks 602 and 604 are for exemplifying purpose, the shapes of the parasitic blocks may be different, and the number of the parasitic blocks may also be increased adequately.

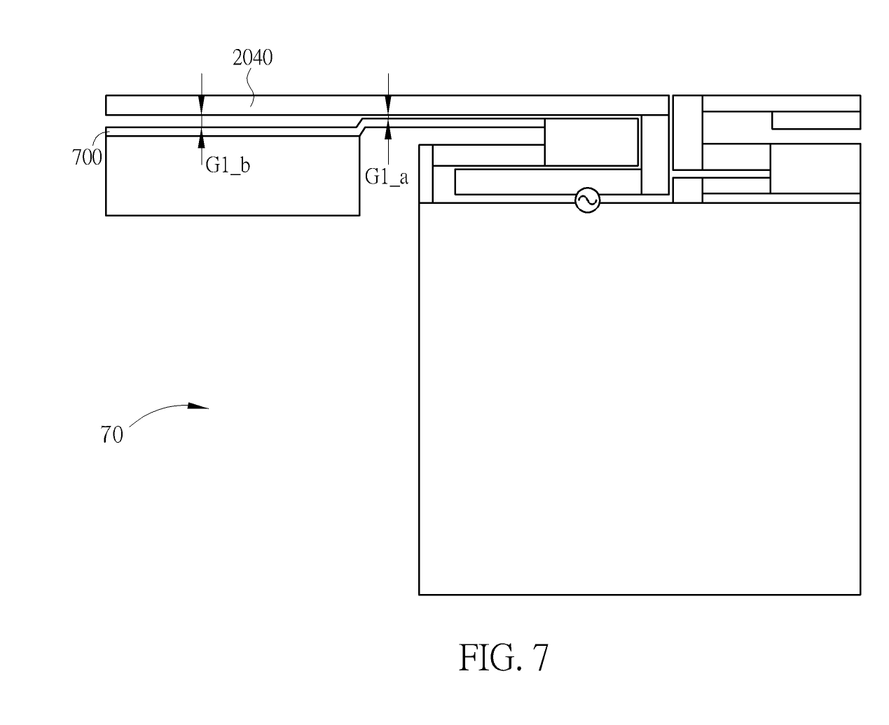

Based on the examples given in FIGS. 6A and 6B, the number and shape of the segments in the second extending radiating element 400 or the parasitic blocks therein may also be adequately adjusted. On the other hand, in FIG. 4A, the gaps G1-G4 are with a same width, but not limited thereto. The gaps G1-G4 may have different widths. Alternatively, each of the gaps G1-G4 may vary either gradually or segmentally. For example, FIG. 7 is a schematic diagram of an antenna 70 according to an embodiment of the present invention. Since the structures of the antennas 70 and 40 are similar, most notations of elements are neglected. Different from the antenna 40, a width of a gap between a segment 700 and the first segment 2040 of an extending radiating element of the antenna 70 varies, forming as a gap G1_a and a gap G1_b. Certainly, in other embodiments, it may include more than two gaps, but not limited thereto. The widths of the gaps G2-G4 may vary either gradually or segmentally, as the previous example.

FIGS. 6A, 6B and 7 are to exemplify that the shape of the first extending radiating element 206 of the antennas 20-30 and the parasitic block thereof may be modified adequately. Similarly, the shape of the second extending radiating element 400 and the parasitic block thereof may also be modified accordingly. Similarly, the length and shape of the extending segment 302, and distance to grounding sheet 200 may be changed based on the system requirements.

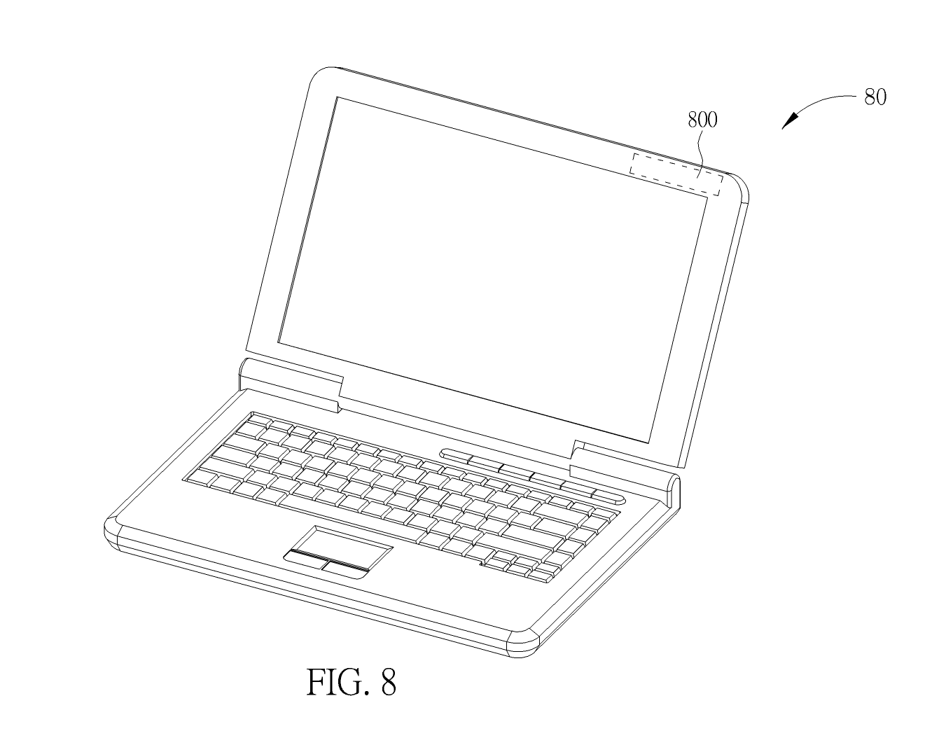

On the other hand, in the embodiments mentioned previously, the antennas 20-40 are exemplarily applied for LTE system. In fact, since antenna properties are related to the size, shape and material thereof, those skilled in the art can make alterations and modifications adequately in terms of the size, shape and material of the antennas 20-40 according to the desired wireless communication system. In addition, since the antennas 20-40 require smaller settling area and have better radiation efficiency, it is more flexible for disposing. For example, FIG. 8 is a schematic diagram of a laptop 80. Due to the small settling area for the antennas 20-40, the antennas 20-40 may be disposed in an area 800 on the top of a monitor of the laptop 80. Hence, in addition to avoiding interference to other electronic devices, extra grounding effect for the parasitic 2068 of the first extending radiating element 206 is obtained by utilizing the grounding element of the monitor, such that antenna properties are further improved.

For a multiband wireless communication system occupying a wide range frequency bands such as LTE system, the prior art method is to equip with multiple antennas to respectively transmit and receive signals of different frequency bands, which causes increase of deign complexity and space for settling the antennas. In comparison, the present invention achieves multiband and wideband operations by a single antenna, requires less settling space, owns good antenna properties, and satisfies requirements of multiband wireless communication systems occupying wide frequency range.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An antenna, for wideband and multiband operations, the antenna comprising:
a grounding sheet, for providing grounding;
a radiating element, extending from a first terminal near an edge of the grounding sheet to a second terminal near the edge of the grounding sheet, comprising at least a bend to substantially encompass an area with the edge of the grounding sheet;
a feeding element, electrically connected to the first terminal of the radiating element, for transmitting electromagnetic energy; and
a first extending radiating element, disposed in the area, electrically connected to the grounding sheet, and substantially zigzagging along the radiating element;
wherein a length of the radiating element is related to a first operating frequency band of the antenna, and a length of the first extending radiating element is related to a second operating frequency band of the antenna.

2. The antenna of claim 1, wherein the radiating element comprises a first segment and a second segment between the first terminal and the second terminal.

3. The antenna of claim 2, wherein the first extending radiating element substantially separates from the first segment by a first gap and from the second segment by a second gap to zigzag alone the first segment and the second segment, wherein the first gap and the second gap are related to a degree of coupling between the radiation element and the first extending radiating element.

4. The antenna of claim 1, wherein the first extending radiating element comprises at least one parasitic block, for adjusting at least one characteristic of the first operating frequency band or the second operating frequency band, and the at least one characteristic is selected from one or both of a matching condition and a frequency range.

5. The antenna of claim 1, wherein the radiating element further comprises an extended segment, electrically connected to the first terminal, and a length of the extending segment is related to a third operating frequency band of the antenna.

6. The antenna of claim 5, wherein the feeding element is electrically connected to the extending segment to electrically connect the first terminal of the radiating element.

7. The antenna of claim 5, wherein a part of the first extending radiating element substantially extends along with the extending segment.

8. The antenna of claim 5, further comprising a second extending radiating element, electrically connected to the grounding sheet, comprising a plurality of segments, wherein a total length of the plurality of segments is related to a fourth operating frequency band of the antenna.

9. The antenna of claim 8, wherein partial segments of the plurality of segments substantially separate from the radiating element by at least a third gap, and the third gap is related to a degree of coupling between the radiation element and the second extending radiating element.

10. The antenna of claim 8, wherein the second extending radiating element further comprises at least one parasitic block, for adjusting at least one characteristic of the fourth operating frequency band, and the at least one characteristic is selected from one or both of a matching condition and a frequency range.

11. The antenna of claim 1, wherein the radiating element comprises a plurality of segments between the first terminal and the second terminal.

12. The antenna of claim 1, wherein the radiating element is arc-shaped by the bend.

13. The antenna of claim 1, wherein the radiating element have variation in width.
